(19) United States
(12) Patent Application Publication
(10) Pub. No.: US 2020/0169015 A1
(43) Pub. Date: May 28, 2020

(54) CONTACT ELEMENT FOR ELECTRICAL PLUG-IN CONNECTIONS

(71) Applicant: WABCO Europe BVBA, Brussels (BE)

(72) Inventors: Thomas BOLIK, Hannover (DE); Juri HARZ, Ronnenberg (DE); Tobias KORTLANG, Gehrden (DE); Tobias WUSTRACK, Barsinghausen (DE)

(21) Appl. No.: 16/317,759

(22) PCT Filed: Jul. 4, 2017
(86) PCT No.: PCT/EP2017/000787

§ 371 Date: Jun. 18, 2019

(30) Foreign Application Priority Data
Jul. 14, 2016 (DE) 10 2016 008 582.7

(51) Int. Cl. H01R 12/70; H01R 13/24

(52) U.S. Cl. CPC H01R 12/7076; H01R 2201/26; H01R 13/2407

(57) ABSTRACT

The invention relates to a contact element (1) for the electrical plug-in connection of electrical or electronic system components (5) to an electronic printed board assembly (6), such as a printed circuit board, for example, wherein the contact element (1) is made of an electrically conductive material and in which the plug-in connector (8a, 8b) of the system component (5) can be connected to the contact element (1) in a force-fitting and electrically conductive manner as a result of a spring effect of said contact element (1). It is furthermore provided that the contact element (1) has two mutually spaced arms (2, 3), each having a circular free end (9, 10), that the arms (2, 3) are connected to one another via a contact portion (4), that, at one end (10), the contact element (1) has an extension piece (22) for the electrical connection to the printed board assembly (6), that the contact element (1) has a cutout (13) over its entire length, that the cutout (13) is narrowed in the contact portion (4) by contact projections (14, 15) projecting into said cutout, whereby a clamping region for the force-fitting and electrically conductive clamping of the plug-in connector (8a, 8b) is formed, and in which the arms (2, 3) are arranged at an angle with respect to the contact portion (4) in such a way that they extend in two different planes.

The invention relates to a contact element for the electrical plug-in connection of electrical or electronic system components to an electronic printed board assembly, such as a printed circuit board, for example, wherein the contact element is made of an electrically conductive material and in which the plug-in connector of the system component can be connected to the contact element in a force-fitting and electrically conductive manner as a result of a spring effect of said contact element. The invention moreover relates to a contact device having a plurality of such contact elements.

In mechatronic systems, for example in systems of motor vehicles, such as anti-lock brake systems (ABS), electronic brake systems (EBS), automatic or automated gear change devices and clutch control devices, electrical plug-in connections are required to provide electrical signals of system components, such as magnetic coils, sensors or magnetic valves, to one or more electronic control units which are integrated in the overall arrangement of the system, and/or to transmit electrical signals or currents from control units to said system components. Electronic control units are conventionally realized by one or more rigid printed circuit boards or flexible traces, which are also referred to as printed board assemblies. However, generic electrical plug-in connections are also required for establishing contact between system components, for example to provide them with the same electrical ground point.

Wired plug-in connections can be used for this purpose. Although these are flexible in terms of their arrangement, they require relatively complex components for connection arrangements and cable harnesses, which result in high component costs and usually increased arrangement dimensions. Flexible trace foils are less robust and thermally less loadable, which means that they are not universally usable. More favorable in terms of cost, overall size and loadability are known electrical direct connection means, such as fork-type plug-in contacts, for instance, which are only a few millimeters in size and are suitable for producing a direct electrical connection between a system component, for example a coil, and a printed circuit board of a control device.

In known plug-in connections, a plug-in tab is plugged into a fork-shaped socket and held mechanically therein as a result of an elastic deformation of a sub-region of the fork. However, this requires a certain normal force, which acts perpendicularly to a bearing surface of the plug-in connector or perpendicularly to the plug-in tab, in order to ensure a mechanically secure plug-in connection and to always maintain electrical contact so that a reliable signal transmission can take place via this connection.

The structure, geometry and overall size of a fork-type contact is determined on the basis that, on the one hand, a necessary spring force has to be provided for maintaining a plug-in connection and, on the other, a plastic deformation of the contact element should be prevented. By the same token, owing to the increasing complexity and number of mechatronic systems, for example advanced driver assistance systems in motor vehicles, there is an increasing demand for the overall size of such electrical plug-in connections to be as compact as possible. In particular, there is a desire for a very flat structure so that it is possible to benefit from even the smallest advantages in terms of space.

DE 10 2013 015 593 A1 discloses a contact system for plug-in connections on electronics housings, having a contact element, formed as a punched part, for contacting mechatronic components on a printed circuit board. The contact element has two arms or contact lugs which are connected to one another by a connecting part, which consists of two webs. A plug-in contact of a mechatronic component can be contacted by a first arm. To this end, this arm has a section with contact projections between which the plug-in contact or a plug-in tab can be clamped in an electrically conductive manner. A second arm is formed to contact the printed circuit board. To produce a flexible connection between the contact arms, the two connecting webs are formed in a zigzag shape. Both arms are bent through approximately 90° with respect to the connecting part, wherein both arms on the connecting part can be angled in the same direction or in opposite directions. The connecting part extends approximately parallel to the plane of the printed circuit board. The arms therefore extend approximately perpendicularly to the plane of the printed circuit board. The overall height of the plug-in connection is determined substantially by the length of the arms. A similar contact element is disclosed in DE 30 24 249 A1.

US 2001/0 049 238 A1 discloses an electrical plug-in contact, consisting of a plug-in zone for receiving a plug-in connector, a connecting zone for the electrical connection of the plug-in contact to an electrical component, and an intermediate zone which is arranged between the plug-in zone and the connecting zone. The plug-in zone is formed as a fork-like socket into which a plug-in tab of the plug-in connector can be plugged, wherein the fork-type contact is widened so that the plug-in tab is held as a result of the spring effect of the material of the fork-type contact. The plug-in zone is arranged in an L-shaped region of the plug-in contact. The plug-in contact is angled a plurality of times in an S-shape in the region of the connecting zone and/or the intermediate zone. The overall height of the plug-in contact is determined substantially by the length of the limbs of the L shape.

Against this background, the invention is based on the object of providing a contact element for electrical plug-in connections on mechatronic systems of the type mentioned at the outset, which has a reduced, in particular flatter, overall height, yet ensures a secure and continuous electrical connection of the components to be connected and is economical to manufacture. In particular, such a contact device should be suitable for reliable contacting of mechatronic systems in motor vehicles. Moreover, a contact device composed of a plurality of such contact elements shall also be proposed.

The invention is based on the recognition that, in the case of a contact device for electrical plug-in connections in mechatronic systems, a fork-shaped electrical contact element can be designed such that it is angled in two directions so as to realize a particularly flat structure. With a relatively narrowly spaced double bending of a contact element, which has been formed from a metal material such as a thin metal sheet, however, a disadvantageous material stiffening occurs in the region in which the angles are formed. This material stiffening leads to a considerable reduction in a spring effect of the material so that a plug-in tab which is plugged into the fork-type contact and should then be held as a result of the spring effect of the material would not be adequately secured in a conventional contact element without further measures.

The aim is to compensate the inadequate spring effect caused by the intrinsically desired angled form by means of resilient regions which, although they lie outside the angled regions, still act resiliently on the contact or clamping portion of the contact element. As a result of a geometrically novel construction of such a contact element, paying particular attention to the spring effect to be achieved, it is possible, in spite of the double angled form and reduced overall height, to achieve a spring effect in the contact or clamping portion of the contact element which is comparable to that of conventional generic contact elements.

The invention therefore starts with a contact element for the electrical plug-in connection of electrical or electronic system components to an electronic printed board assembly, such as a printed circuit board, for example, wherein the contact element is made of an electrically conductive material and in which the plug-in connector of the system component can be connected to the contact element in a force-fitting and electrically conductive manner as a result of a spring effect of said contact element.

To achieve said object, the invention provides that the contact element has two mutually spaced arms, that the two arms each have a circular free end, that the two arms are connected to one another via a contact portion, that, at one end, the contact element has an extension piece for the electrical connection to the printed board assembly, that the contact element has a cutout over its entire length, that the cutout is narrowed in the contact portion by contact projections projecting into said cutout, whereby a clamping region for the force-fitting and electrically conductive clamping of the plug-in connector of the system component is formed, and in which the two arms are arranged at an angle with respect to the contact portion in such a way that they extend in two different planes.

A twice-bent, economically producible contact element with a comparatively small installation height is provided by the invention. A normal contact force required for securely holding a plug-in connector by means of the spring effect of the contact element is achieved by a special construction of the arms of the contact element. Accordingly, in contrast to previous fork-type contacts, a fork-shaped contact portion is proposed, which, following each longitudinally extending side, is elongated by a respective angled or bent arm. The arms have a circular portion at their free ends and the contact portion and the arms have a cutout which extends over the entire length of the contact element. Owing to this cutout, the two arms each consist of two substantially mutually parallel arranged limbs and the contact portion also has two substantially mutually parallel limbs. The cutout is designed such that it narrows in the contact portion and, more precisely, in such a way that this narrowing has a width which is smaller than the thickness of an electrical plug-in connector of a system component to be contacted.

By means of the invention, it was possible to discover a configuration for a contact element which meets the requirements of a compact, in particular very flat structure on the one hand and a high spring force in the normal direction of a plug-in connector on the other. In this case, a contact element having a longitudinally directed cutout is produced, which has two bent arms on both sides of a contact portion, which each have a annular free end. The internally open contact element, which can be produced as a punched part and has a curved contour, extends between the ends of the arms. When the arms are pressed apart, the circular ends of the contact element generate a spring force which wants to restore the contact portion arms to their starting position. In this case, compared to an angular form of the ends of the arms of the contact element, the annular geometry thereof advantageously prevents the production of notch stresses.

This construction of the contact element generates a spring force when the plug-in connector of a system component to be contacted is introduced into the narrowing in the contact portion. In this case, the limbs of the arms are pressed apart and their inherent restoring effect generates a normal force acting on the plug-in connector which holds this latter on the contact element.

In this case, the contact portion of the contact element is aligned so that a plug-in connector of a system component, for example a protruding plug-in tab on an electrical coil, is aligned approximately perpendicularly to the plane of the contact portion and thereby penetrates this latter. The contact portion is therefore aligned approximately in the plug-in direction of the plug-in connector so that the plug-in connector can be easily plugged into the contact element.

The double angled form of the contact element can be adapted to the respective structural properties of an application. To this end, it can be provided that the first arm and the second arm are aligned at an angle with respect to the contact portion of the contact element, each in an angular range of 30° to 120°, including the range limits, wherein both angles can be formed to be the same size or different sizes.

According to a preferred embodiment of the contact element, it can be provided that the first arm is bent through approximately 90° with respect to the contact portion of the contact element and extends approximately parallel to a plane of the system component to be contacted, and that the second arm is bent through approximately 90° in the opposite direction to the first arm with respect to the contact portion and extends approximately parallel to a plane of the printed board assembly, i.e. a printed circuit board, for example, and that the plug-in connector can be plugged into the contact portion approximately perpendicularly to the two arms.

Another further development of the invention provides that, owing to the cutout in the contact element, the two arms and the contact portion are each formed by two limbs and that the geometry of the limbs and the ends thereof enables a spring force to be generated, which, in the region of the contact portion, acts on a plug-in connector of the system component, which is received in the contact portion.

It can moreover be provided that, in the region of the contact portion, the arms or their limbs have insertion chamfers for easier insertion of a plug-in connector of a system component into the contact element, wherein the insertion chamfers narrow the cutout in the contact element continuously with a sloping progression.

By means of the contact projections, a comparatively high surface pressure can be exerted on the plug-in connecter of a system component which is to be contacted. The spring force provided by the contact element on the plug-in connector in the normal direction is thus used particularly effectively to hold the plug-in connector in the contact portion. Owing to the angled form of the contact element, the contact portion can be aligned precisely in the plug-in direction of the plug-in connector. Since the plug-in direction of the plug-in connector is in the contact plane of the contact portion, an advantageous insertion chamfer for the plug-in connector can be formed via the contact projections. The plugging-in of the plug-in connector when assembling the plug-in connection can thus be carried out particularly easily and securely.

According to another embodiment of the invention, it can be provided that the contact element is arranged on a supporting element, wherein the ends of the arms are fixed on the supporting element by means of latching connections, and that the supporting element has at least one opening for guiding the plug-in connector of a system component through into the contact portion of the contact element.

The plug-in connection is given particularly good stability by means of a supporting element. This can be advantageous in particular in sensitive systems which are exposed to constant vibrations or shocks. Moreover, such a supporting element enables the compensation of assembly and manufacturing tolerances of the plug-in connection or the components to be contacted. To fix the contact element on the supporting element, latching elements, onto which the annularly formed ends of the contact element can be easily pushed with a slight radial play, can be attached to the housing or formed thereon. The radial play is designed such that it does not adversely affect the contribution of the ends of the contact element to the potential spring force thereof.

According to a further embodiment, it can be provided that the extension piece at the end of the contact element is formed for direct attachment to and contact with a component of the printed board assembly, such as a lead frame. Lead frames are frequently used individually or also stacked as particularly compact distributors of electrical currents and signals in complex control devices of mechatronic systems. By means of a simple, for example rod-shaped or plate-shaped, extension piece on the contact element, a permanent direct connection between the contact element and a lead frame or a similar printed-circuit-board type part of a printed board assembly and components arranged thereon can be produced simply and economically.

The contact device according to the invention enables the construction of a standard connecting plug, which generates a high spring force for securely holding a plug-in connector over the whole of the envisaged useful life of the respective device, but has a reduced height compared to existing systems. A contact element formed according to the invention can have a length of 2.6 mm to 3.0 mm and a height of 0.6 mm to 1.0 mm, for example.

According to another embodiment, it can be provided that the extension piece on the contact element is formed with an angle, wherein the angled portion is longer than the non-angled portion of the extension piece. It is thereby also advantageously possible to realize contact means on the printed board assembly which are arranged laterally adjacent and remote from the contact element

The invention also relates to a contact device having a plurality of contact elements which have at least the features described in claim 1, and which is characterized in that a plurality of contact elements are arranged for a plurality of electrical contacts or for a plurality of phases of an electrical contact, wherein these contact elements are orientated in the same directions in terms of the angle of their arms so that their extension pieces point in the same directions. The associated contact means of a printed board assembly can thus be realized particularly easily.

According to an alternative embodiment of such a contact device, it is provided that a plurality of contact elements are arranged for a plurality of electrical contacts or for a plurality of phases of an electrical contact, wherein these contact elements are orientated in opposite directions in terms of the angle of their arms so that their extension pieces point in opposite directions. This enables contacting of the associated contact means of two printed board assemblies, i.e. two printed circuit boards, for example, which are arranged on opposite sides, near to the extension-piece ends of the respective contact elements.

A multiplicity of electrical plug-in connections can be provided in a mechatronic system. The contact element according to the invention can therefore be advantageously installed in any number and arrangement. In this case, a reduced size of the overall system can be achieved by an appropriate alignment of the contact devices.

Further embodiments of the invention provide that the two arms and the contact portion are each formed by two limbs and a first limb of a first arm is connected to a first limb of a second arm via a first limb of a first contact portion and a second limb of a first arm is connected to a second limb of a second arm via a second limb of a second contact portion.

It can furthermore be provided that the first limb of the first arm is connected in one piece to the first limb of the second arm via the first limb of the first contact portion and the second limb of the first arm is connected in one piece to the second limb of the second arm via the second limb of the second contact portion.

It can furthermore be provided that the two arms can be connected to one another in one piece via the contact portion. It should be understood from this that, after the clamping of the plug-in connector of the electronic system component, there is direct contact between the limbs of the two arms via the limbs of the contact portion. It can furthermore be provided that the two arms are connected to one another in one piece via the contact portion.

The invention is explained in more detail below with reference to the exemplary embodiments illustrated in the accompanying drawing, which shows:

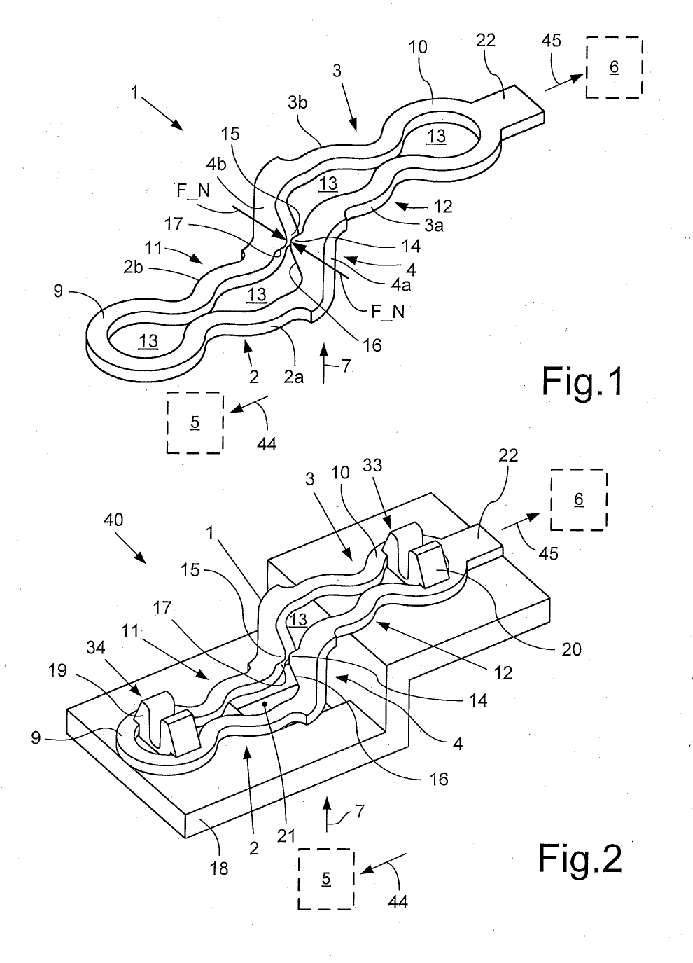

FIG. 1 a perspective view of a contact element according to a first embodiment;

FIG. 2 a perspective view of the contact element according to FIG. 1, which is attached to a supporting element;

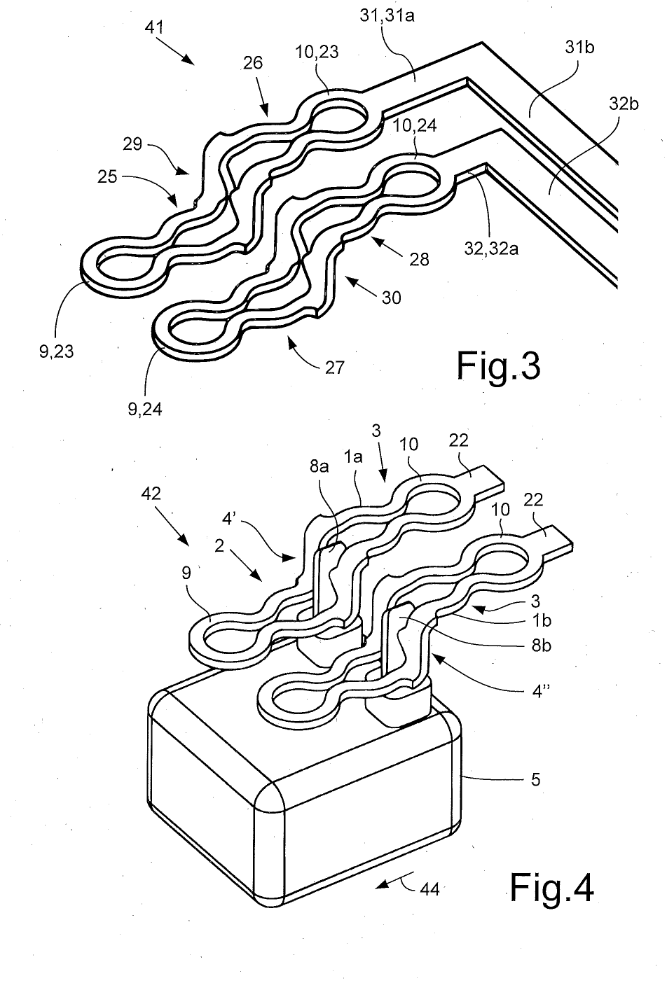

FIG. 3 a perspective view of two contact elements with long extension pieces according to a second embodiment;

FIG. 4 a perspective view of two contact elements aligned in the same direction, which are connected to plug-in connectors, and

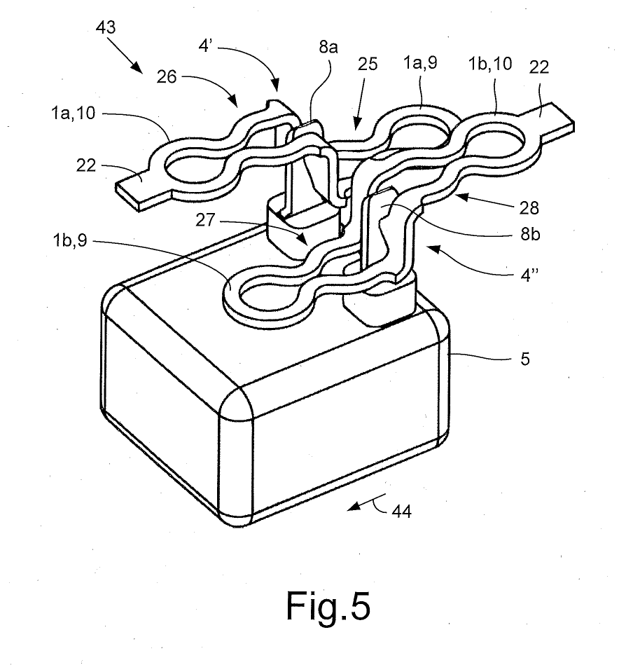

FIG. 5 a perspective view of two contact elements aligned in opposite directions, which are connected to plug-in connectors.

The contact element 1 shown in FIG. 1 is provided for use in a contact device for electrical plug-in connections, for example in a mechatronic system. It has been punched from a metal, electrically conductive material in the form of a thin metal sheet and subsequently or simultaneously bent. The contact element 1 has an elongated stepped geometry with a contour which has multiple curves.

The contact element 1 has two arms 2, 3 which are connected to one another via a contact portion 4 formed between them. Moreover, the contact element 1 has a cutout 13 which extends over its entire length. As a result of the cutout 13, the arms 2, 3 are each formed by two limbs 2a, 2b; 3a, 3b and the contact portion 4 also consists of two limbs 4a, 4b. The two limbs 4a, 4b of the contact portion 4 narrow the cutout 13 to a slight gap for here receiving a plug-in connector 8a, 8b of an element to be contacted and clamping it in an electrically conductive manner.

The two arms 2, 3 start at the contact portion 4 and are aligned at an angle on this in two directions, in each case through 90°. The first arm 2 therefore extends approximately in the direction of the longitudinal extent 44 of a system component 5 to be contacted, for example an electrical coil or a sensor, and the second arm 3 extends approximately in the direction of the longitudinal extent 45 of a component of a printed board assembly 6, for example a printed circuit board. The contact portion 4 extends approximately in the plug-in direction 7 of the plug-in connector 8a, 8b of the system component 5 (see FIG. 4 and FIG. 5).

In the region of the contact portion 4 of the contact element 1, two contact projections 14, 15 projecting inwardly into the cutout 13 are formed on said contact element for clamping the plug-in connector 8a, 8b to be received there on two sides. The two contact projections 14, 15 are formed with insertion chamfers 16, 17 in the plug-in direction 7 for easier insertion of a plug-in connector 8a, 8b and are operative in this direction.

The two arms 2, 3 have annular ends 9, 10 which point away from the contact portion 4. The cutout 13 in the contact element 1 extends into the circular ends 9, 10. An intermediate region 11, 12, which has a curved contour and is formed as a spring region, extends between the two ends 9, 10 and the contact portion 4 in each case. The two circular ends 9, 10 of the arms 2, 3 and the two spring regions 11, 12 are formed and cooperate in such a way that the contact element 1 as a whole has spring properties. When a plug-in connector 8a, 8b is plugged in between the two contact projections 14, 15 in the plane of the contact portion 4, this spring property of the contact element 1 generates a spring force F_N, which is directed inwards and thereby clamps, holds and establishes continuous electrical contact with the plug-in connector 8a, 8b in the cutout 13 (FIGS. 4 and 5).

Moreover, a rod-shaped or plate-shaped extension piece 22 is arranged or formed at the end 10 of that second arm 3 which is provided for attachment to the printed board assembly 6, which extension piece can be connected to a printed circuit board or a lead frame with press fit, for example. With a varying geometrical shape, the extension piece 22 enables a wide variety of different contacting means to be electrically and mechanically attached there. These other contacting means can be press-in contacts, soldered contacts or a bonding pad for a bonding wire connection, for example.

As shown in FIG. 2, in the case of the contact device 40 therein, the annular ends 9, 10 of the arms 2, 3 of the contact element 1 can be used for a first latching connection 33 and a second latching connection 34 to a supporting element 18. To this end, a respective latching element 19, 20 is latched to an associated annular end 9, 10 of the arms 2, 3 with a slight radial play. The two latching elements 19, 20 are arranged in an appropriate position for this on the supporting element 18 and are fixedly connected thereto, for example produced in one piece therewith.

In terms of its surface, the supporting element 18 is clearly adapted to the angled form and to the contact portion 4 of the contact element 1 and to the geometry of the arms 2, 3 and, in the exemplary embodiment shown, is designed as a stepped plate with the appropriate geometry. Moreover, the supporting element 18 has an opening 21, which serves as a passage for a plug-in connector 8a, 8b of a system component 5 to be contacted. The supporting element 18 can be provided for attachment to associated base plates or surfaces which support the components to be electrically connected by the contact element 1. However, the supporting element 18 can also be formed as a contacting module, a housing or part of a housing, for instance a housing cover, a housing wall or a housing base.

FIG. 3 shows a second contact device 41 having two contact elements 23, 24 which are formed substantially in the manner of the contact element 1 according to FIG. 1. Each of these two contact elements 23, 24 therefore has a first two-limbed arm 25, 27 and second two-limbed arm 26, 28, which are connected to one another via a separate two-limbed contact portion 29, 30 in each case. The second arms 26, 28 on the printed-circuit-board side are provided with elongated extension pieces 31, 32. These elongated extension pieces 31, 32 are each aligned such that they are angled through 90° in the plane of the arms 26, 28 connected thereto and can be connected for example to a lead frame (not illustrated). It can be seen in each case that the portion 31b, 32b of the extension piece 31, 32 which is angled away from the contact element 23, 24 is longer than the non-angled portion 31a, 32a. The two contact elements 23, 24 can thus be arranged parallel next to one another and connected via the respective extension pieces 31, 32 to another component or a printed circuit board or a lead frame which, in terms of the alignment of its contact points, is likewise aligned parallel to the contact elements 23, 24.

FIG. 4 shows a third contact device 42 having two contact elements 1a, 1b which are formed in the manner of the contact element 1 according to FIG. 1. These two contact elements 1a, 1b are aligned parallel and in the same direction with respect to one another and to a system component 5, which is illustrated as a coil housing of an electrical coil here. This system component 5 has two electrical plug-in connectors 8a, 8b, which are formed as plug-in tabs, and are plugged into, and clamped in, the respective contact portions 4′, 4″ of the associated contact elements 1a, 1b in an electrically conductive manner. In this case, contact is established for example by a movement of the two contact elements 1a, 1b in the direction of the system component 5 or, alternatively, by a movement of the system component 5 towards the two contact elements 1a, 1b. In this case, to realize functional contacting, it is not important whether the system component 5 is arranged as illustrated in FIG. 4 or rotated through 180° about its vertical axis. In the latter case, the housing of the system component 5 would be arranged below the second arms 3 of the two contact elements 1a, 1b.

Finally, FIG. 5 shows a fourth contact device 43 similar to that according to FIG. 4, although in which the two contact elements 1a, 1b are aligned in opposite directions. It is clear that the respective extension pieces 22 therefore point in opposite directions whilst the two plug-in connectors 8a, 8b of the system component 5 are plugged into, and clamped in, the respective contact portions 4′, 4″ of the associated contact elements 1a, 1b in an electrically conductive manner.

1. A contact element for electrical connection of an electrical plug-in connector of electrical or electronic system components to an electronic printed board assembly, the contact element comprising:
a first arm and a second arm, wherein the two arms each have a circular free end, wherein the two arms are connected to one another via a contact portion, wherein, at one end, the contact element has an extension piece for the electrical connection to the printed board assembly, wherein the contact element has a cutout over its entire length, wherein the cutout is narrowed in the contact portion by contact projections projecting into the cutout;
wherein a clamping region for a force-fitting and electrically conductive clamping of the plug-in connector of the system component is formed; and
wherein the two arms are arranged at an angle with respect to the contact portion in such a way that the two arms extend in two different planes.

2. The contact element as claimed in claim 1, wherein the first arm and the second arm are aligned at an angle with respect to the contact portion of the contact element, each in an angular range of from 30° to 120°, including the range limits.

3. The contact element as claimed in claim 2, wherein the first arm is bent through 90° with respect to the contact portion of the contact element and extends approximately parallel to a plane of the system component to be contacted, wherein the second arm is bent through 90° in the opposite direction to the first arm with respect to the contact portion and extends parallel to a plane of the printed board assembly, and wherein the plug-in connector can be plugged into the contact portion approximately perpendicularly to the two arms.

4. The contact element as claimed in claim 1, wherein the first arm and the second arm are aligned at same-sized or different-sized angles to the contact portion.

5. The contact element as claimed in claim 1, wherein, owing to the cutout in the contact element, the two arms and the contact portion in the contact element are each formed by two limbs,
and wherein the geometry of the limbs and the ends of the arms enables the contact element to generate a spring force which, in the region of the contact portion, acts on a plug-in connector of the system component, which is received in the contact portion.

6. The contact element as claimed in claim 5, wherein, in the region of the contact portion, the limbs have insertion chamfers for easier insertion of the plug-in connector of a system component into the contact element, and wherein the insertion chamfers narrow the cutout in the contact element continuously with a sloping progression.

7. The contact element as claimed in claim 1, wherein the contact element is arranged on a supporting element, wherein the ends of the arms are fixed on the supporting element by employing latching connections, and wherein the supporting element has at least one opening for guiding the plug-in connector of a system component through into the contact portion of the contact element.

8. The contact element as claimed in claim 7, wherein a respective latching element of the supporting element is received in an annular end of the contact element.

9. The contact element as claimed in claim 1, wherein the extension piece on the contact element is formed for direct attachment to and contact with a component of the printed board assembly.

10. The contact element as claimed in claim 1, wherein the extension piece on the contact element is formed with an angle, wherein the angled portion is longer than the non-angled portion of the extension piece.

11. A contact device comprising a plurality of contact elements according to claim 1, wherein the plurality of contact elements are arranged for a plurality of electrical contacts or for a plurality of phases of an electrical contact, and wherein these contact elements are orientated in the same direction in terms of the angle of their arms so that their extension pieces point in the same direction.

12. A contact device having a plurality of contact elements according to claim 1, wherein a plurality of contact elements are arranged for a plurality of electrical contacts or for a plurality of phases of an electrical contact, and wherein these contact elements are orientated in opposite directions in terms of the angle of their arms so that their extension pieces point in opposite directions.

13. The contact element as claimed in claim 1, wherein the two arms and the contact portion are each formed by two limbs and a first limb of a first arm is connected to a first limb of a second arm via a first limb of a first contact portion and a second limb of a first arm is connected to a second limb of a second arm via a second limb of a second contact portion.

14. The contact element as claimed in claim 13, wherein the first limb of the first arm is connected in one piece to the first limb of the second arm via the first limb of the first contact portion and the second limb of the first arm is connected in one piece to the second limb of the second arm via the second limb of the second contact portion.

15. The contact element as claimed in claim 1, wherein the two arms are configured to be connected to one another in one piece via the contact portion.

16. The contact element as claimed in claim 1, wherein the two arms are connected to one another in one piece via the contact portion.

17. The contact element of claim 1, wherein the contact element comprises an electrically conductive material.

18. The contact element of claim 1, wherein the plug-in connector of the system component is configured to be connected to the contact element in a force-fitting and electrically conductive manner as a result of a spring effect of the contact element.

19. The contact element of claim 1, wherein the electronic printed board assembly comprises a printed circuit board.

20. The contact element of claim 9, wherein the component of the printed board assembly comprises a lead frame.
